(19) United States
(12) Patent Application Publication
(10) Pub. No.: US 2009/0231598 A1
(43) Pub. Date: Sep. 17, 2009

(54) Image processing apparatus, image processing method, and computer program product

(75) Inventor: Shuji Kimura, Kanagawa (JP)

Correspondence Address: HARNESS, DICKEY & PIERCE, P.L.C., P.O. BOX 8910, RESTON, VA, 20195, US

(73) Assignee: Ricoh Company, Limited.

(21) Appl. No.: 12/379,975

(22) Filed: Mar. 5, 2009

(30) Foreign Application Priority Data
Mar. 12, 2008 (JP) 2008-063205

(51) Int. Cl. G06K 15/02; G06K 9/32

(52) U.S. Cl. 358/1.2; 382/298

(57) ABSTRACT

A user sets up an original on a document reading device and inputs an operation mode [M] and magnification [Z] associated with magnification distribution, other setups, and a command for starting an application to be used using an operation display device. The information input by the user is informed to a CPU. The CPU executes an operation process program of the application to be used and determines, with respect to the operation mode [M] and the modification [Z] specified by the user, optimal magnification distribution between magnification [Z1] of a magnification changing unit in a first image data processing device and magnification [Z2] of a magnification changing unit in a second image data processing device.

### CROSS-REFERENCE TO RELATED APPLICATIONS

The present application claims priority to and incorporates by reference the entire contents of Japanese priority document 2008-063205 filed in Japan on Mar. 12, 2008.

### BACKGROUND OF THE INVENTION

1. Field of the Invention

The present invention generally relates to a technology for processing image data in an image processing apparatus.

2. Description of the Related Art

In recent years, an image processing apparatus has been proposed process image data before sending the image data to an external personal computer (PC) or the like so that high definition image quality can be achieved at the PC, as disclosed in, for example, Japanese Patent Application Laid-open No. 2006-270816.

Japanese Patent Application Laid-open No. 2005-109857 discloses an image processing apparatus that can convert a resolution to a plurality of resolutions while reducing memory requirement without reducing image processing rate and with a simple architecture.

Further, Japanese Patent Application Laid-open No. 2003-191535 discloses an image formation controlling apparatus (a printer) that can efficiently obtain an output result that is scaled larger or smaller at a quality level as desired by a user while maintaining image quality depending on image forming conditions and avoiding reduction in processing rate.

Japanese Patent Application Laid-open No. 2005-269379 discloses an image processing system that enables a user to specify a magnification (i.e., resolution) when sending image data stored in a memory within an image processing-apparatus to an external device, such as a personal computer.

However, although the apparatuses disclosed in Japanese Patent Application Laid-open No. 2006-270816, Japanese Patent Application Laid-open No. 2005-109857, and Japanese-Patent Application Laid-open No. 2003-191535 include first and second magnification changing units as in the present invention, those apparatuses lack a mechanism for determining an optimal magnification depending on various conditions, and therefore cannot respond to a wide variety of needs based on users' intended purposes (e.g., usages, environments).

In addition, although the apparatus disclosed in Japanese Patent Application Laid-open No. 2005-269379 includes a magnification changing unit that can change a magnification of image data stored in an image storage unit as in the present invention, the apparatus still lacks the mechanism for determining an optimal magnification depending on various conditions, and therefore cannot respond to a wide variety of needs based on users' intended purposes (e.g., usages, environments).

### SUMMARY OF THE INVENTION

It is an object of the present invention to at least partially solve the problems in the conventional technology.

According to an aspect of the present invention, there is provided an image processing apparatus including a first magnification changing unit that processes input image data at a first magnification thereby obtaining first magnification image data; an image storage unit that stores therein the first magnification image data; a second magnification changing unit that processes the first magnification image data at a second magnification thereby obtaining second magnification image data; an image output unit that outputs any one of the first magnification image data obtained by the first magnification changing unit, the first magnification image data in the image storage unit, and the second magnification image data obtained by the second magnification changing unit as output image data; a magnification setting unit that sets a magnification of the output image data that is to be output from the image output unit; an operation mode setting unit that sets an operation mode from among an image quality priority mode, a productivity priority mode, and a balance priority mode in which image quality and productivity are balanced; and a magnification distribution controlling unit that controls magnification distribution between the first magnification and the second magnification based on the operation mode set by the operation mode setting unit and the magnification set by the magnification setting unit.

According to another aspect of the present invention, there is provided an image processing method including first processing including processing input image data at a first magnification thereby obtaining first magnification image data and storing the first magnification image data in an image storage unit; second processing including processing the first magnification image data at a second magnification thereby obtaining second magnification image data; outputting any one of the first magnification image data obtained at the first processing, the first magnification image data in the image storage unit, and the second magnification image data obtained at the second processing as output image data; magnification setting including setting a magnification of the output image data that is to be output at the outputting; mode setting including setting an operation mode from among an image quality priority mode, a productivity priority mode, and a balance priority mode in which image quality and productivity are balanced; and controlling magnification distribution between the first magnification and the second magnification based on the operation mode set at the mode setting and the magnification set at the magnification setting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of relevant components of an image processing apparatus according to an embodiment of the present invention;

FIG. 2 is a block diagram of an exemplary configuration of a first image data processing device shown in FIG. 1;

FIG. 3 is a block diagram of an exemplary configuration of a second image data processing device shown in FIG. 1;

FIG. 4 is a block diagram of an exemplary configuration of a central processing unit (CPU) shown in FIG. 1;

FIG. 5 is a schematic of ranges for assigning resolutions and corresponding resolutions to be assigned in a static resolution determining unit shown in FIG. 4;

FIG. 6 is a schematic of adjustment values to a static resolution determined in the static resolution determining unit shown in FIG. 4; and

FIGS. 7A and 7B depict a flowchart of an operation performed by the image processing apparatus shown in FIG. 1.

### DETAILED DESCRIPTION OF THE PREFERRED EMBODIMENTS

With reference to the accompanying drawings, exemplary embodiments of the present invention will be described in detail below. Note that, in these embodiments, the image processing apparatus will be described, by way of example, as an image forming apparatus, in particular a digital multi function product (MFP) that includes a combination of a plurality of functions such as those found in a copier, a scanner, a printer, and a facsimile machine.

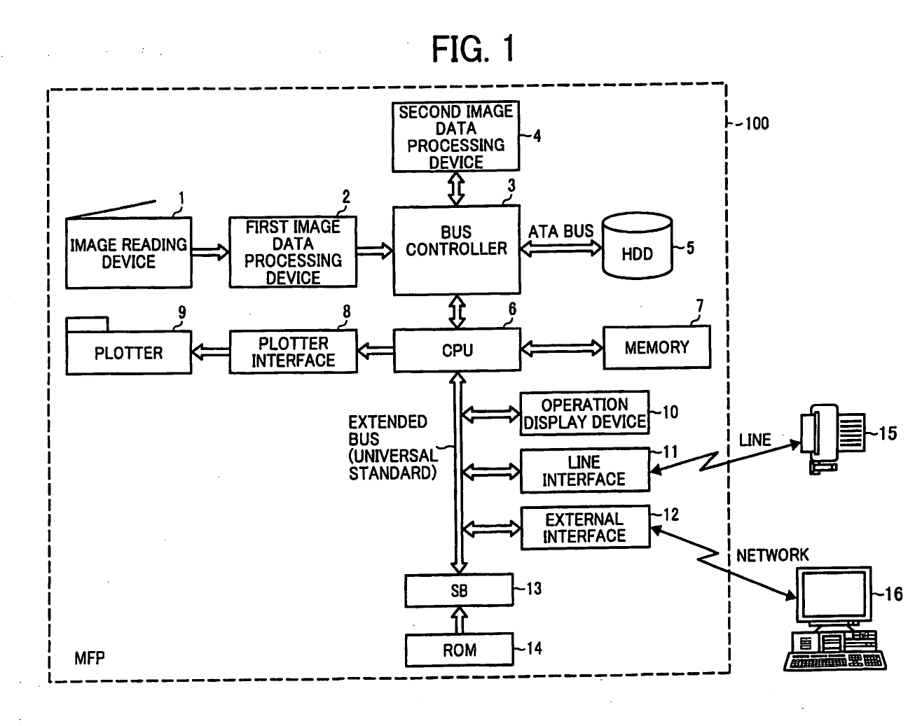

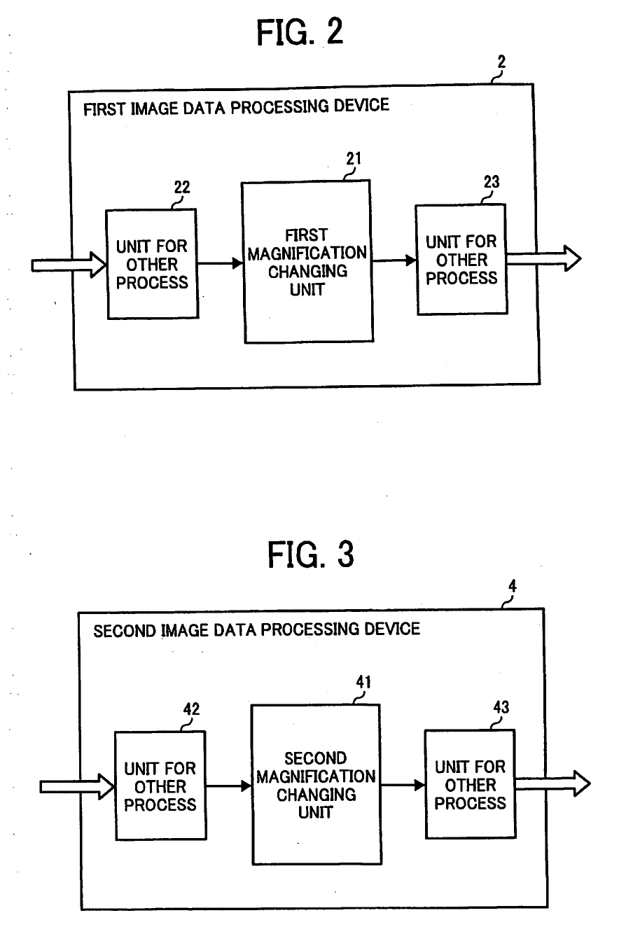

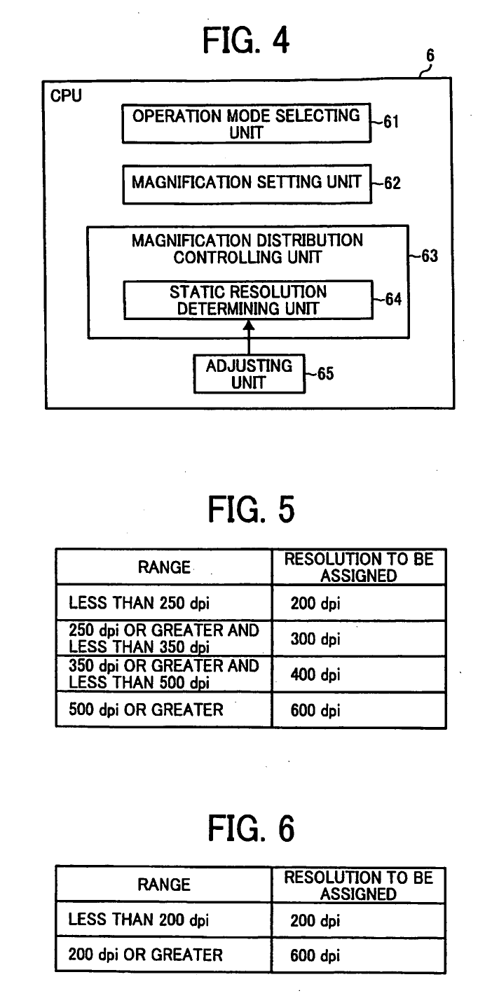

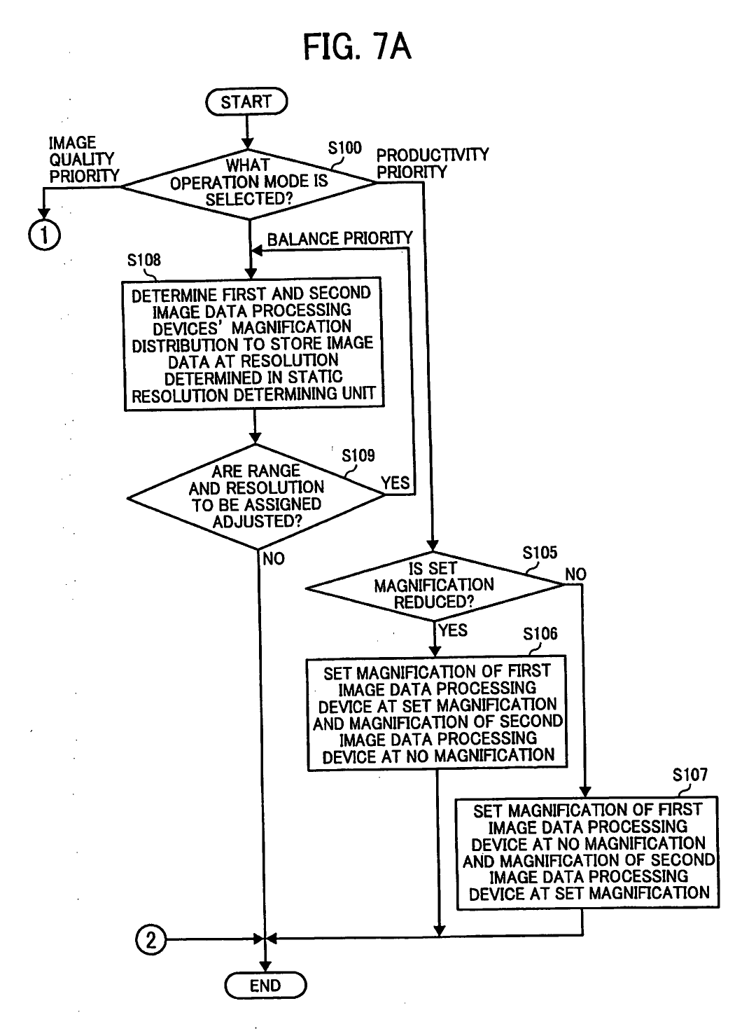

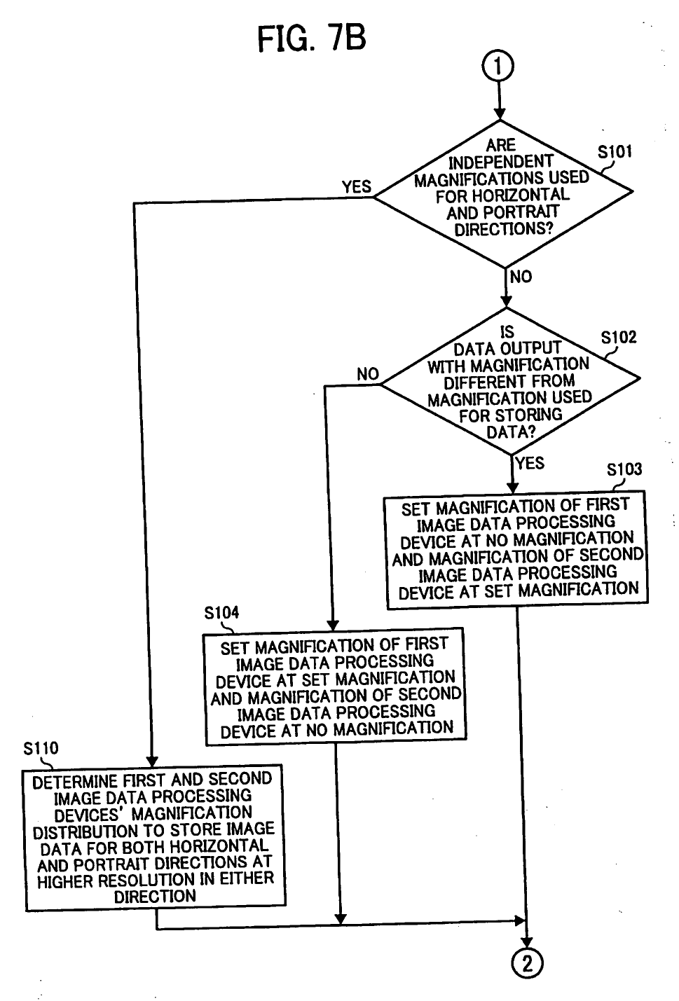

FIG. 1 is a block diagram of relevant components of an image processing apparatus 100 according to an embodiment of the present invention. FIG. 2 is a block diagram of an exemplary configuration of a first image data processing device 2 shown in FIG. 1. FIG. 3 is a block diagram of an exemplary configuration of a second image data processing device 4 shown in FIG. 1. FIG. 4 is a block diagram of an exemplary configuration of a central processing unit (CPU) 6 shown in FIG. 1. FIG. 5 is a schematic of ranges for assigning resolutions and corresponding resolutions to be assigned in a static resolution determining unit 64 shown in FIG. 4. FIG. 6 is a schematic of adjustment values to a static resolution determined in the static resolution determining unit 64. FIGS. 7A and 7B depict a flowchart of an operation performed by the image processing apparatus 100.

The image processing apparatus 100 illustrated in FIG. 1 is an MFP and includes an image reading device 1 that reads an image; the first image data processing device 2 including a first magnification changing unit (see FIG. 2); a bus controller 3; the second image data processing device 4 including a second magnification changing unit (see FIG. 3); a hard disk drive (HDD) 5 that stores therein an image; the CPU 6 including an operation mode selecting function, a magnification setting function, a magnification distribution controlling function, a static resolution determining function, and an adjusting function; a memory 7 that stores therein an image; a plotter interface 8; a plotter 9 connected to the plotter interface 8 and that outputs (prints) an image; an operation display device 10; a line interface 11; an external interface 12; a south bridge (SB) 13; and a read only memory (ROM) 14. The MFP 100 is connected to an external facsimile machine 15 via a telephone line or to a personal computer (PC) 16 via a network.

The image reading device 1 includes a line sensor having a photoelectric conversion device such as a charge coupled device (CCD), an analog to digital (A/D) converter, and a drive circuit for each of the line sensor and A/D converter. The image reading device 1 generates and outputs image data, for example, RGB image data having eight bits for each of R, G, and B in this embodiment, from gray scale information obtained by scanning an original set in a reading position. The image reading device 1 can mechanically change magnification of an image in a sub-scanning direction by changing scanning speed therein, which is herein referred to as a sub-scanning mechanical magnification change. It is assumed that the image reading device 1 has a normal reading resolution of 600 dpi when no magnification is applied.

The first image data processing device 2 includes, as illustrated in FIG. 2, for example, a first magnification changing unit 21 that changes magnification (resolution) of input image data, and units for other processing 22 and 23 on either sides of the first magnification changing unit 21. Each of these component units can process as appropriate the image data from the image reading device 1 depending on various conditions. The units for other processing 22 and 23 perform image processing other than changing magnification, such as gamma correction, filtering, or color conversion.

The bus controller 3 is a controller for a data bus that communicates various types of data such as image data and control commands required to control the MFP 100, and also has a bridging function between a plurality of types of bus standards. The bus controller 3 is connected to the first image data processing device 2, the second image data processing device 4, and the CPU 6 via a PCI-Express bus, and connected to the HDD via an AT attachment (ATA) bus to be ASIC.

The second image data processing device 4 includes, as illustrated in FIG. 3, for example, a second magnification changing unit 41 that changes magnification (resolution) of input image data, and units for other processing 42 and 43 on either sides of the second magnification changing unit 41. Each of these component units can further process as appropriate the image data stored in the memory 7 that has been processed as appropriate in the first image data processing device 2. The units for other processing 42 and 43 perform image processing other than changing magnification, such as filtering, color conversion (from RGB to CMYK), or tone processing on the image data that has been processed in the first image data processing device 2.

The HDD 5 is typically a large capacity storage device that stores therein electronic data such as data used for a PC. The HDD 5 is used primary for storing therein image data and information associated therewith. A hard disk that is connected via an ATA bus that is standardized by extending integrated drive electronics (IDE) is used as the HDD 5. The HDD 5, along with the memory 7, functions to store therein image data.

The CPU 6 is a microprocessor for governing all control in the MFP 100. The CPU 6 is an integrated CPU that has recently gained popularity and in which a single CPU core is supplemented by one or more added functions; however, some other type of CPU can be used. For example, a CPU may be used having integrated therein a function for connecting with at least one of a universal standard interface and a function for connecting buses using a cross-bar switch, such as RM 11100 manufactured by PMC-Sierra, Inc.

The memory 7 is a volatile memory that temporally stores therein data being communicated temporarily and computer programs and intermediate processing data when the CPU 6 controls the MFP 100. The memory 7 is operative to accommodate a difference in speed when bridging a plurality of types of bus standards or a difference in processing rate of connected units. The CPU 6 boots a system using a boot program stored in the ROM 14 during a normal startup. Subsequently, because the CPU 6 requires high-speed processing, the process is continued by a computer program operated in the memory 7, which is accessible at high speed. In this embodiment, the memory 7 is a standard double inline memory module (DIMM) that is used in PCs.

The plotter interface 8 outputs the processed image data. The plotter interface 8 receives CMYK (cyan, magenta, yellow, and black) image data sent via a universal standard interface integrated in the CPU 6 and performs bus bridge processing to output the image data to a dedicated interface for the plotter 9. In this embodiment, the universal standard interface is a PCI-Express bus.

The plotter 9 receives the CMYK image data from the plotter interface 8 and prints out the received image data on paper (transfer paper) as a visible image using, for example, an electrophotographic process with a laser beam.

The operation display device 10 is an interface between the MFP 100 and a user and includes a display unit such as a liquid crystal display (LCD) and a switch such as a key switch. The operation display device 10 displays various statuses and operation procedures of the MFP 100 on the LCD and detects key switch input by the user. In this embodiment, the operation display device 10 is connected to the CPU 6 via a PCI-Express bus. In addition, in this embodiment, as one of the conditions for determining magnification distribution, the user is allowed to select an operation mode with an operation mode selecting unit 61 in the CPU 6 shown in FIG. 4, which is hereinafter referred to as operation mode selection.

The line interface 11 is an interface for connecting the PCI-Express bus and the telephone line and enables the MFP 100 to communicate various types of data with devices such as the facsimile machine 15 via the telephone line. The line interface 11 functions that outputs an image.

The external interface 12 is a device that connects the PCI-Express bus and an external device such as the PC 16, and enables the MFP 100 to communicate various types of data with the PC 16. In this embodiment, the interface for connection is a network (Ethernet (registered trademark)). That is, the MFP 100 is connected to a network via the external interface 12, and the external interface 12 functions as an image output unit.

The SB 13 is one of the chipsets used in PCs and is a universal electronic device. The SB 13 is a universal circuit form of bridge functions widely used in building a CPU system that primarily includes a PCI-Express and an ISA bridge. In this embodiment, the SB 13 is a bridge to the ROM 14.

The ROM 14 is a memory that stores therein computer programs (including a boot program) that are executed when the CPU 6 controls the MFP 100.

The facsimile machine 15 is a conventional facsimile machine and receives and transmits the image data from/to the MFP 100 via the telephone line.

The PC 16 is a personal computer as an external device. Various types of control data and image data can be input to the MFP 100 by the user and output from the MFP 100 to the user via application software and one or more drivers installed in the PC.

The MFP 100 provides application functions to the user, for example, copy, printer, scanner delivery, facsimile transmission, document box (D-Box) output, copy plus D-Box, scanner delivery plus D-Box, and facsimile transmission plus D-Box functions.

In the copy function, the image reading device 1 reads an original image. Then, the image data thereof is processed in the first and the second image data processing devices 2 and 4, and subsequently sent to the plotter 9 to be printed on paper as a visible image.

In the printer function, print data, such as character codes or drawing data, input from the PC 16 via a network is sent to the plotter 9 in an expanded form as image data and printed on paper as a visible image.

In the scanner delivery function, the image reading device 1 reads an original image. Then, the image data thereof is delivered to external device(s) such as the PC 16 that are preset in an e-mailing mechanism or the like by the external interface 12.

In the D-Box output function, the image data stored in the HDD 5 is sent to the plotter 9 to be printed on paper as a visible image, delivered to external device(s) such as the PC 16 preset in an e-mailing mechanism or the like by the external interface 12, or delivered to one or more external devices such as the facsimile machine 15 preset by the line interface 11.

In the copy plus D-Box function, the image reading device 1 reads an original image. The image data thereof is, while being stored in the HDD5, sent to the plotter 9 and printed on paper as a visible image.

In scanner delivery plus D-Box function, the image reading device 1 reads an original image. The image data thereof is, while being stored in the HDD 5, delivered to external device(s) such as the PC 16 preset in an e-mailing mechanism or the like by the external interface 12.

In the facsimile delivery plus D-Box function, the image reading device 1 reads an original image. The image data thereof is, while being stored in the HDD 5, delivered to one or more external devices such as the facsimile machine 15 preset by the line interface 11.

As shown in FIG. 4, the CPU 6 includes the operation mode selecting unit 61 that selects an operation mode, a magnification setting unit 62 that sets a magnification, and a magnification distribution controlling unit 63 that controls a magnification distribution.

A magnification distribution between the first magnification changing unit 21 shown in FIG. 2 and the second magnification changing unit 41 shown in FIG. 3 is controlled depending on an operation mode that is arbitrarily selected by the user and on a magnification to be used for outputting the image data. In this embodiment, the operation modes include, by way of example, image quality priority mode and productivity priority mode, either of which is selected.

The operation mode selecting unit 61 in the CPU 6 shown in FIG. 4 displays an operation mode selection menu on an operation screen in the operation display device 10 in FIG. 1 for a user to select an operation mode. When the user selects an operation mode, the magnification setting unit 62 in the CPU 6 in FIG. 4 sets a magnification for outputting the image data according to the operation mode selected by the user. The magnification distribution controlling unit 63 controls the magnification distribution to be optimal between the first and second magnification changing units 21 and 41 based on the selected operation mode and the set magnification.

The first embodiment describes an operation when any application is used. Initially, the user sets up an original on the image reading device 1 shown in FIG. 1. Then, the user inputs an operation mode [M] that will have influence on the magnification distribution, overall magnification [Z], other settings (if any), and a command for starting an application to be used through the operation display device 10.

The operation display device 10 converts the information input by the user to control command data in the apparatus and sends those control command data to the CPU 6 via the PCI-Express bus.

The CPU 6 executes an operation process program of the application to be used according to the control command data for staring the application, so as to determine an optimal distribution between magnification [Z1] of the first magnification changing unit 21 in the first image data processing device 2 and magnification [Z2] of the second magnification changing unit 41 in the second image data processing device 4 based on the user-selected operation mode [M] and the overall magnification [Z].

With respect to the magnification [Z1] distributed to the first image data processing device 2, changing a scanning rate of the image reading device 1 in the sub-scanning direction can further optimally distribute the magnification [Z1] utilizing a sub-scanning mechanical magnification change to change a magnification of an image in the sub-scanning direction. In doing so, the other settings and operations required for the used application should be performed. The operation process will be particularly described below.

The image data obtained by scanning an original with the image reading device 1 shown in FIG. 1 is converted with the magnification [Z1], optimally distributed to the first image data processing device 2, subjected to other processing as required, and sent to the bus controller 3. The bus controller 3 receives the image data from the first image data processing device 2 and stores the image data in the memory 7 via the CPU 6. If the used application is stored in the D-Box, the image data stored in the memory 7 is stored in the HDD 5. This process is referred to as a process A and will be referenced below.

The image data stored in the memory 7 is sent to the second image data processing device 4 via the CPU 6 and the bus controller 3. The second image data processing device 4 converts the received image data to have the optimally distributed magnification [Z2], performs other processes as required thereon, and outputs the resultant image data back to the memory 7.

If the used application is related to a printing operation, the image data stored in the memory 7 is sent to the plotter 9 via the CPU 6 and the plotter interface 8. The plotter 9 outputs the received image data onto transfer paper to generate a copy of the original.

On the other hand, if the used application is related to a transmission operation to external device(s), the image data stored in the memory 7 is sent to the device(s) external to the MFP 100 via the CPU 6 and the line interface 11 or the external interface 12.

Next, in the process A, a scenario in which the user desires to output the image data already stored in the HDD 5 again based on any conditions, that is to say, in which the stored image data is reused will be described. Initially, the user requests to output the data stored in the D-Box with a magnification [ZZ]. The image data stored in the HDD 5 is sent to and stored in the memory 7 via the CPU 6. This image data stored in the memory 7 is sent to the second image data processing device 4 via the CPU 6 and the bus controller 3. The second image data processing device 4 performs a conversion with the magnification [Z2] and other necessary processes on the received image data and outputs the resultant image data. The magnification [Z2] is calculated based on the magnification [ZZ] of the data stored in the D-Box and the resolution of the image data stored in the memory 7. Then, the bus controller 3 receives the image data from the second image data processing device 4 and stores the received image data in the memory 7 via the CPU 6.

If the used application is related to a printing operation, the image data stored in the memory 7 is sent to the plotter 9 via the CPU 6 and the plotter interface 8. The plotter 9 outputs the received image data onto transfer paper to generate a copy of the original. On the other hand, if the used application is related to a transmission operation to external device(s), the image data stored in the memory 7 is sent to the device(s) external to the MFP 100 via the CPU 6 and the line interface 11 or the external interface 12.

In the operation mentioned above, with reference to FIGS. 7A and 7B for the magnification distribution control flow in the magnification distribution controlling unit 63, if the image quality priority mode is selected in the operation mode selection block (an image quality priority branch from Step S100 in FIG. 7A) and if horizontal magnification is the same as portrait magnification (No at Step S101 in FIG. 7B) and if the image data is output with the same magnification as that used for storing the data (No at Step S102), the magnification of the first image data processing device 2 will be the set magnification and the magnification of the second image data processing device 4 will be no magnification (Step S104).

In this way, according to the first embodiment, based on the operation mode arbitrary selected by the user in the operation mode selecting unit 61 and the magnification for outputting the image data set in the magnification setting unit 62, magnification is optimally distributed between the first and second magnification changing units 21 and 41 by the magnification distribution controlling unit 63. Therefore, the image processing apparatus can be realized to respond to a wide variety of needs depending on the user's intended purpose (e.g., usage, environment).

In a second embodiment of the present invention, image quality can be set higher when outputting stored image data at a magnification different from that used for storing the data. A condition for this magnification distribution control is to select the image quality priority mode for outputting the stored image data at conditions different from those used for storing the data. In this embodiment, a scenario in which the image data is copied with 50% magnification in size and stored in the D-Box will be described.

Initially, the user sets up an original on the image reading device 1 shown in FIG. 1. Then, the user selects the image quality priority mode in the operation mode selecting unit 61 in the CPU 6 using the operation display device 10, performs other setups (if any), and then inputs commands for starting 50% magnification copy and accumulation to the D-Box.

The operation display device 10 converts the information input by the user to control command data in the apparatus and sends the control command data to the CPU 6 via the PCI-Express bus. The CPU 6 executes an operation process program of the copy plus D-Box accumulation service according to the control command data for staring the service, so as to distribute, with respect to the magnification [Z: 50%] specified by the user, a magnification [Z1: 100% (no magnification)] to the first magnification changing unit 21 in the first image data processing device 2 and a magnification [Z2: 50%] to the second magnification changing unit 41 in the second image data processing device 4. The operation process will be sequentially described below.

The image data obtained by scanning an original with the image reading device 1 is changed in magnification with the magnification [Z1: 100% (no magnification)] and subjected to the other required processes in the first image data processing device 2, and then sent to the bus controller 3.

The bus controller 3 receives the image data to which magnification changing processing is applied (in this case, no magnification) in the first image data processing device 2 and stores the image data in the memory 7 via the CPU 6. Further, the image data stored in the memory 7 is also stored in the HDD 5. This process is referred to as a process B and will be referenced below. The image data stored in the memory 7 and the HDD 5 at this point has a resolution of 600 dpi (no-magnification reading resolution).

Subsequently, the image data stored in the memory 7 is sent to the second image data processing device 4 via the CPU 6 and the bus controller 3. The second image data processing device 4 converts the received image data to have the optimally distributed magnification [Z2: 50%], performs other processes as required, and then outputs the resultant image data.

The bus controller 3 receives the image data output from the second image data processing device 4, and stores the image data in the memory 7 via the CPU 6. The image data stored in the memory 7 is sent to the plotter 9 via the CPU 6 and the plotter interface 8. The plotter 9 outputs the received image data onto transfer paper to generate a copy of the original.

In the process B, a scenario in which the user desires to output the image data stored in the HDD 5 based on conditions different from the prior conditions (in which the stored image data is reused later) will be described below. Initially, the user requests to deliver the data at 200 dpi using the scanner, the data being stored in the D-Box. Then, the image data stored in the HDD 5 is stored in the memory 7 via the CPU 6. The image data stored in the memory 7 is sent to the second image data processing device 4 via the CPU 6 and the bus controller 3. The second image data processing device 4 converts the received image data to have the magnification [Z2: 33% (corresponding to 200 dpi)], performs other processes as required, and then outputs the resultant image data.

The bus controller 3 receives the image data processed in the second image data processing device 4, and stores the image data in the memory 7 via the CPU 6. The image data stored in the memory 7 is sent to one or more devices external to the MFP 100 via the CPU 6 and the external interface 12.

In the operation as mentioned above, with reference to FIGS. 7A and 7B for the magnification distribution control flow in the magnification distribution controlling unit 63, if the image quality priority mode is selected in the operation mode selection block (the image quality priority branch from Step S100 in FIG. 7A) and if horizontal magnification is the same as portrait magnification (No at Step S101 in FIG. 7B) and if the image data is output with a magnification different from that used for storing the data (Yes at Step S102), the magnification of the first image data processing device 2 will be no magnification and the magnification of the second image data processing device 4 will be the set magnification (Step S103).

In this way, according to the second embodiment, the image data is stored at no-magnification reading resolution and the magnification distribution in the magnification distribution controlling unit 63 is controlled to output the image data based on the conditions different from those used for storing the data. Therefore, even if the output resolution of the stored image data is reset, actually only one magnification variation processing has to be done, resulting in reduced image quality degradation and thus enabling to always output high-quality image data.

In a third embodiment of the present invention, productivity (throughput) can be increased without degrading image quality when image data is output. A condition for this magnification distribution control is to select the productivity priority mode for outputting the image data. In the third embodiment, a scenario in which the image data is copied with 50% magnification in size will be described.

Initially, the user sets up an original on the image reading device 1 shown in FIG. 1. Then, the user selects the productivity priority mode in the operation mode selecting unit 61 in the CPU 6 using the operation display device 10, performs other setups (if any), and then inputs a command for starting 50% magnification copy.

The operation display device 10 converts the information input by the user to control command data in the apparatus and sends the control command data to the CPU 6 via the PCI-Express bus. The CPU 6 executes a copy operation process program according to the control command data for staring the service, so as to distribute, with respect to the magnification [Z: 50%] specified by the user, a magnification [Z1: 50%] to the first magnification changing unit 21 in the first image data processing device 2 and a magnification [Z2: 100% (no magnification)] to the second magnification changing unit 41 in the second image data processing device 4.

In the third embodiment, a scenario will be described in which, with respect to the magnification [Z1: 50%] distributed to the first image data processing device 2, the magnification in the sub-scanning direction is further distributed such that the sub-scanning mechanical magnification of the image reading device 1 is [50%] and the magnification of the first magnification changing unit 21 in the first image data processing device 2 is [Z1: 100% in the sub-scanning direction]. The operation process will be sequentially described below.

The image data is obtained by the image reading device 1 by scanning an original with the sub-scanning mechanical magnification being [50%]. Then, the obtained image data is changed in magnification with the magnification [Z1: 50% in the main-scanning direction/100% in the sub-scanning direction] and subjected to other required processes in the first image data processing device 2, and sent to the bus controller 3.

The bus controller 3 receives the image data from the first image data processing device 2 and stores the image data in the memory 7 via the CPU 6. The image data stored in the memory 7 at this point has a resolution of 300 dpi (corresponding to the output resolution with 50% magnification in size).

Subsequently, the image data stored in the memory 7 is sent to the second image data processing device 4 via the CPU 6 and the bus controller 3. The second image data processing device 4 converts the received image data to have the optimally distributed magnification [Z2: 100% (no magnification)], performs other processes as required, and then outputs the resultant image data.

The bus controller 3 receives the image data output from the second image data processing device 4, and stores the image data in the memory 7 via the CPU 6. The image data stored in the memory 7 is sent to the plotter 9 via the CPU 6 and the plotter interface 8. The plotter 9 outputs the received image data onto transfer paper to generate a copy of the original.

In the operation as mentioned above, with reference to FIGS. 7A and 7B for the magnification distribution control flow in the magnification distribution controlling unit 63, if the productivity priority mode is selected in the operation mode selection block (a productivity priority branch from Step S100 in FIG. 7A) and if a set magnification is reduction (Yes at Step S105), then the magnification of the first image data processing device 2 will be the set magnification and the magnification of the second image data processing device 4 will be no magnification (Step S106).

In this way, according to the third embodiment, the magnification is distributed such that the image data is stored at the output resolution. Therefore, if a reduced (lower) output resolution is set, the image data handled after the first image data processing device can be reduced in size, therefore resulting in reduced processing load thereafter and thus improved processing rate. As can be seen in the hardware arrangement in FIG. 1, load on the bus controller 3 can be reduced, leading to improved processing rate. Further, combining the third embodiment with the mechanical magnification change in the image reading device 1 can achieve further improvement on processing rate. With respect to the image quality, except when the stored image data is output based on conditions different from those used for storing the data, actually only one magnification variation processing has to be done, therefore enabling to output high-quality image data without image quality degradation.

In a fourth embodiment of the present invention, productivity (throughput) can be improved when image data is output in an enlarged form. A condition for this magnification distribution control is to select the productivity priority mode when the image data is to be output in an enlarged form. In the fourth embodiment, the operation in which the image data is copied with 200% magnification will be described.

Initially, the user sets up an original on the image reading device 1 shown in FIG. 1. Then, the user selects the productivity priority mode in the operation mode selecting unit 61 in the CPU 6 using the operation display device 10, performs other setups (if any), and then inputs a command for starting 200% magnification copy. The fourth embodiment presupposes that the productivity priority mode is selected as in the third embodiment, and the operation mode according to this embodiment is further selected.

The operation display device 10 converts the information input by the user to control command data in the apparatus and sends the control command data to the CPU 6 via the PCI-Express bus. The CPU 6 executes a copy operation process program according to the control command data for staring the copy service, so as to distribute, with respect to the magnification [Z: 200%] specified by the user, a magnification [Z1: 100% (no magnification)] to the first magnification changing unit 21 in the first image data processing device 2 and a magnification [Z2: 200%] to the second magnification changing unit 41 in the second image data processing device 4. The operation process will be sequentially described below.

The image data obtained by scanning an original with the image reading device 1 is converted with the magnification [Z1: 100% (no magnification)] and subjected to other required processes in the first image data processing device 2, and sent to the bus controller 3.

The bus controller 3 receives the image data from the first image data processing device 2 and stores the image data in the memory 7 via the CPU 6. The image data stored in the memory 7 at this point has a resolution of 600 dpi (no-magnification reading resolution).

Subsequently, the image data stored in the memory 7 is sent to the second image data processing device 4 via the CPU 6 and the bus controller 3. The second image data processing device 4 converts the received image data to have the optimally distributed magnification [Z2: 200%], performs other processes as required, and then outputs the resultant image data.

The bus controller 3 receives the image data output from the second image data processing device 4, and stores the image data in the memory 7 via the CPU 6. The image data stored in the memory 7 is sent to the plotter 9 via the CPU 6 and the plotter interface 8. The plotter 9 outputs the received image data onto transfer paper to generate a copy of the original.

In the operation as mentioned above, with reference to FIGS. 7A and 7B for the magnification distribution control flow in the magnification distribution controlling unit 63, if the productivity priority mode is selected in the operation mode selection block (the productivity priority branch from Step S100) and if a set magnification is not reduction (No at Step S105), then the magnification of the first image data processing device 2 will be no magnification and the magnification of the second image data processing device 4 will be the set magnification (Step S107).

In this way, according to the fourth embodiment, productivity can be improved without image quality degradation at the magnification corresponding to image enlargement, thus further improving the advantageous effect of the third embodiment as mentioned above. In the third embodiment, the magnification is always distributed such that the image data is stored at the output resolution. Therefore, once the output resolution is set to the resolution equivalent to the image enlargement, the image data handled after the first image data processing device 2 becomes larger in size than that of the reading resolution, therefore resulting in increased processing load thereafter and thus reduced processing rate. On the contrary, in the fourth embodiment, when the magnification corresponds to image enlargement, the magnification is distributed such that the image data is stored at no-magnification reading resolution. Therefore, it is possible to output the image data without processing rate reduction due to the increased image data size. In addition, with respect to image quality, even if an output resolution is reset, actually only one magnification changing processing has to be done, enabling to output high-quality image data without any image degradation.

In a fifth embodiment of the present invention, conflicting advantages and disadvantages of the image quality priority mode and the productivity priority mode are traded off to achieve a balance. In the fifth embodiment, an operation in which scanner delivery is performed at a resolution of 270 dpi and the image data is stored in the D-Box will be described.

Initially, the user sets up an original on the image reading device 1 shown in FIG. 1. Then, the user selects the balance priority mode in the operation mode selecting unit 61 in the CPU 6 using the operation display device 10, performs other setups (if any), and then inputs commands for starting scanner delivery at the resolution of 270 dpi and accumulation to the D-Box.

The operation display device 10 converts the information input by the user to control command data in the apparatus and sends the control command data to the CPU 6 via the PCI-Express bus. The CPU 6 executes the scanner delivery plus D-Box accumulation service operation process program according to the control command data for staring the service, so as to distribute, with respect to the magnification [Z: 45% (corresponding to 270 dpi)] specified by the user, the magnification between the first magnification changing unit 21 in the first image data processing device 2 and the second magnification changing unit 41 in the second image data processing device 4 such that the image data is stored at a static resolution determined in the static resolution determining unit 64 in FIG. 4.

In the fifth embodiment, an example of ranges for assigning resolutions and corresponding resolutions to be assigned in the static resolution determining unit 64 in FIG. 4 is shown in FIG. 5. Based on what is shown in FIG. 5, the magnification [Z1: 50% (corresponding to 300 dpi)] is distributed to the first magnification changing unit 21 in the first image data processing device 2 and the magnification [Z2: 90% (corresponding to 270 dpi)] is distributed to the second magnification changing unit 41 in the second image data processing device 4.

In other words, in the fifth embodiment, a scenario will be described in which, with respect to the magnification [50% (corresponding to 300 dpi)] distributed to the first image data processing device 2, the magnification in the sub-scanning direction is further distributed such that the sub-scanning mechanical magnification of the image reading device 1 is [50%] and the magnification of the second magnification changing unit 41 in the second image data processing device 4 is [Z2: 90% (corresponding to 270 dpi)]. The operation process will be sequentially described below.

The image data is obtained by the image reading device 1 by scanning an original with the sub-scanning mechanical magnification being [50%]. Then, the obtained image data is changed in magnification with the magnification [Z1: 50% (corresponding to 300 dpi)] and subjected to other required processes in the first image data processing device 2, and sent to the bus controller 3.

The bus controller 3 receives the image data from the first image data processing device 2 and stores the image data in the memory 7 via the CPU 6. The image data stored in the memory 7 is further stored in the HDD 5, which is referred to as a process C, and will be referenced below. The image data stored in the memory 7 and the HDD 5 at this point has a resolution of 300 dpi.

Subsequently, the image data stored in the memory 7 is sent to the second image data processing device 4 via the CPU 6 and the bus controller 3. The second image data processing device 4 converts the received image data to have the optimally distributed magnification [Z2: 90% (corresponding to 270 dpi)], performs other processes as required, and then outputs the resultant image data.

The bus controller 3 receives the image data output from the second image data processing device 4, and stores the image data in the memory 7 via the CPU 6. The image data stored in the memory 7 is sent-to the device(s) external to the MFP 100 via the CPU 6 and the line interface 11.

In the process C, the operation when the user outputs the image data stored in the HDD 5 based on conditions different from those used for a prior output (the image data stored in the HDD 5 is reused later) is basically similar to the process B in the second embodiment as mentioned above, thus is not further described.

In the operation as mentioned above, with reference to FIGS. 7A and 7B for the magnification distribution control flow in the magnification distribution controlling unit 63, the balance priority mode is selected in the operation mode selection block (a balance priority branch from Step S100), the magnification of the first and the second image data processing devices are determined such that the image data is stored in the HDD 5 to have the static resolution determined in the static resolution determining unit 64 (Step S108).

In this way, according to the fifth embodiment, it is possible to balance the image quality priority mode and the productivity priority mode. For example, the image quality priority mode has an advantage in that image quality can be improved, however, also has a disadvantage in that processing rate is decreased when the magnification corresponds to reduction, because the image quality priority mode distributes the magnification such that the image data is stored at no-magnification reading resolution whatever the output magnification is. On the contrary, the productivity priority mode has an advantage in that processing rate can be improved, however, also has a disadvantage in that image quality is degraded because the magnification is distributed to store the image data at the output resolutions whatever the output magnification is. The conflicting advantages and disadvantages of the image quality priority mode and the productivity priority mode, respectively, can be traded off to achieve a balance to obtain an advantageous effect depending on the user's intended purpose.

In a sixth embodiment of the present invention, the user is allowed to adjust the range for assigning resolutions and corresponding resolutions to be assigned determined in the static resolution determining unit 64 in the fifth embodiment by presetting them using the operation display device 10 in the MFP 100.

Initially, the user inputs set values of the “range” and the “resolutions to be assigned” as shown in FIG. 6 into the operation display device 10. Then, the user sets up an original on the image reading device 1 shown in FIG. 1, selects the balance priority mode in the operation mode selecting unit 61 in the CPU 6 and performs other setups using the operation display device 10, and then inputs commands for starting scanner delivery at the resolution of 270 dpi and accumulation to the D-Box.

The operation display device 10 converts the information input by the user to control command data in the apparatus and issues the data. The issued control command data is informed to the CPU 6 via a PCI-Express bus. The CPU 6 executes the scanner delivery plus D-Box accumulation service operation process program according to the control command data for staring the service, so as to distribute, with respect to the magnification [Z: 45% (corresponding to 270 dpi)] specified by the user, the magnification between the first magnification changing unit 21 in the first image data processing device 2 and the second magnification changing unit 41 in the second image data processing device 4 such that the image data is stored at a static resolution determined in the static resolution determining unit 64 in FIG. 4. Then, based on the preset adjustment values in FIG. 6, the magnification [Z1: 100% (corresponding to no magnification: 600 dpi)] is distributed to the first magnification changing unit 21 in the first image data processing device 2 and the magnification [Z2: 45% (corresponding to 270 dpi)] is distributed to the second magnification changing unit 41 in the second image data processing device 4. The operation process will be sequentially described below.

The image data is obtained by the image reading device 1 by scanning an original with the sub-scanning mechanical magnification being [45% (corresponding to 270 dpi)]. Then, the obtained image data is processed with the magnification [Z1: 100% (corresponding to no magnification)] and subjected to other required processes in the first image data processing device 2, and sent to the bus controller 3.

The bus controller 3 receives the image data from the first image data processing device 2 and stores the image data in the memory 7 via the CPU 6. The image data stored in the memory 7 is further stored in the HDD 5. This is referred to as a process D and will be referenced below. The image data stored in the memory 7 and the HDD 5 at this point has a resolution of 600 dpi.

Subsequently, the image data stored in the memory 7 is sent to the second image data processing device 4 via the CPU 6 and the bus controller 3. The second image data processing device 4 converts the received image data to have the optimally distributed magnification [Z2: 45%], performs other processes as required, and then outputs the resultant image data.

The bus controller 3 receives the image data output from the second image data processing device 4, and stores the image data in the memory 7 via the CPU 6. The image data stored in the memory 7 is sent to the device(s) external to the MFP 100 via the CPU 6 and the line interface 11.

In the process D, the operation when the user outputs the image data stored in the HDD 5 based on conditions different from those used for a prior output (the image data stored in the HDD 5 is reused later) is basically similar to the process B in the second embodiment, thus is not further described.

In the operation as mentioned above, with reference to FIGS. 7A and 7B for the magnification distribution control flow in the magnification distribution controlling unit 63, the balance priority mode is selected in the operation mode selection block (the balance priority branch from Step S100). Then, the magnification is distributed between the first and the second image data processing devices such that the image data is stored in the HDD 5 at the static resolution determined in the static resolution determining unit 64 (Step S108). Then, adjustment is performed when the ranges and resolutions to be assigned are adjusted (Step S109). After that, the process returns to Step S108.

In this way, according to the sixth embodiment, the user is allowed to adjust the ranges for assigning resolutions and corresponding resolutions to be assigned, which are determined in the static resolution determining unit 64 in the fifth embodiment, making it possible to respond to a wider variety of needs.

In a seventh embodiment of the present invention, image quality is given priority when separate magnifications are used for the horizontal and portrait directions. In the seventh embodiment, an operation in which 40% height by 80% width reduced magnification copy and the D-Box accumulation are performed will be described.

The user sets up an original on the image reading device 1 shown in FIG. 1, selects the image quality priority mode in the operation mode selecting unit 61 in the CPU 6 when independent magnifications are used for the horizontal and portrait directions and performs other setups (if any) using the operation display device 10, and then inputs commands for starting 40% height by 80% width reduced magnification copy and accumulation to the D-Box. The seventh embodiment presupposes that the balance priority mode described in the fifth embodiment is selected, and the operation mode according to this embodiment is further selected. Note that the expression of “40% height by 80% width” means 40% magnification in the main-scanning direction and 80% magnification in the sub-scanning direction.

The operation display device 10 converts the information input by the user to control command data in the apparatus and sends the control command data to the CPU 6 via the PCI-Express bus. The CPU 6 executes the copy plus D-Box accumulation service operation process program according to the control command data for staring the service, so as to distribute, with respect to the magnification [Z: 40% in the main-scanning direction/80% in the sub-scanning direction] specified by the user, the magnification [Z1: 80% in the main-scanning direction/80% in the sub-scanning direction] to the first magnification changing unit 21 in the first image data processing device 2 and the magnification [Z2: 50% in the main-scanning direction/100% (no magnification) in the sub-scanning direction] to the second magnification changing unit 41 in the second image data processing device 4.

In the seventh embodiment, a scenario will be described in which, with respect to the magnification [Z1: 80% in the main-scanning direction/80% in the sub-scanning direction] distributed to the first image data processing device 2, the magnification in the sub-scanning direction is further distributed such that the sub-scanning mechanical magnification of the image reading device 1 is [80%] and the magnification of the first magnification changing unit 21 in the first image data processing device 2 is [Z1: 100% in the sub-scanning direction]. The operation process will be sequentially described.

The image data is obtained by the image reading device 1 by scanning an original with the sub-scanning mechanical magnification being [80%]. Then, the obtained image data is changed in magnification with the magnification [Z1: 80% in the main-scanning direction/100% in the sub-scanning direction] and subjected to other required processes in the first image data processing device 2, and sent to the bus controller 3.

The bus controller 3 receives the image data from the first image data processing device 2 and stores the image data in the memory 7 via the CPU 6. The image data stored in the memory 7 is further stored in the HDD 5. This is referred to as a process E and will be referenced below. The image data stored in the memory 7 and the HDD 5 at this point has a resolution of 480 dpi in each of the main and sub scanning directions (corresponding to 80% magnification of the output resolution in the sub-scanning direction).

Subsequently, the image data stored in the memory 7 is sent to the second image data processing device 4 via the CPU 6 and the bus controller 3. The second image data processing device 4 converts the received image data to have the optimally distributed magnification [Z2: 50% in the main-scanning direction/100% (no magnification) in the sub-scanning direction], performs other processes as required, and then outputs the resultant image data.

The bus controller 3 receives the image data output from the second image data processing device 4, and stores the image data in the memory 7 via the CPU 6. The image data stored in the memory 7 is sent to the plotter 9 via the CPU 6 and the plotter interface 8. The plotter 9 outputs the received image data onto transfer paper to generate a copy of the original.

In the process E, the operation when the user outputs the image data stored in the HDD 5 based on conditions different from those used for a prior output (the image data stored in the HDD 5 is reused later) is basically similar to the process B in the second embodiment as mentioned above, thus is not further described.

In the operation as mentioned above, with reference to FIGS. 7A and 7B for the magnification distribution control flow in the magnification distribution controlling unit 63, if the image quality priority mode is selected in the operation mode selection block (the image quality priority branch from Step S100) and when independent magnifications are used for the horizontal and portrait directions (Yes at Step S101), then the magnification distribution between the first and the second image data processing devices 2 and 4 is determined such that the image data is stored for both resolution set in either direction (Step S110).

In this way, according to the seventh embodiment, even when the image data is magnified with different main-scanning and sub-scanning magnifications, image quality can have priority. For example, in the fifth embodiment, the magnification is always distributed such that the image data is stored at the static resolution whatever the output magnification is. Therefore, when the output resolution is set with different main-scanning and sub-scanning magnifications, the resolutions of the stored image data in the main- and sub-scanning directions are different, and thus image quality may be degraded. On the contrary, in the seventh embodiment, when the image data is magnified with different main-scanning and sub-scanning magnifications, the magnification is distributed such that the image data is stored for both main- and sub-scanning directions at a higher resolution set in either direction. Therefore, the stored image data will have the same resolution in both directions, thus the image quality can be improved.

The computer programs executed in the image processing apparatus according to any of the embodiments as mentioned above are provided in a manner incorporated in the ROM 14 shown in FIG. 1 or the like.

Computer programs executed in the image processing apparatuses according to the embodiments may be configured to be embodied as an installable format or executable format file stored in a computer readable recoding medium such as a CD-ROM, a flexible disk (FD), a CD-R, or a digital versatile disk (DVD).

Further, computer programs executed in the image processing apparatuses according to the embodiments may be stored in a computer connected to a network, such as the Internet, and downloaded via the network. In addition, such computer programs may be provided or delivered via a network, such as the Internet.

Computer programs executed in the image processing apparatuses according to the embodiments are configured in a modular format including each unit described above (the operation mode selecting unit 61, the magnification setting unit 62, the magnification distribution controlling unit 63, the static resolution determining unit 64, and an adjusting unit 65, for example). In practical hardware, the CPU (processor) 6 reads and executes a computer program in the ROM 14 to load each of the units described above to a main memory so as to provide on the main memory the operation mode selecting unit 61, the magnification setting unit 62, the magnification distribution controlling unit 63, the static resolution determining unit 64, and the adjusting unit 65, for example.

According to one aspect of the present invention, it is possible to respond to a wide variety of needs according to various intended purposes including users' usages and environments.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a first magnification changing unit that processes input image data at a first magnification thereby obtaining first magnification image data;
an image storage unit that stores therein the first magnification image data;
a second magnification changing unit that processes the first magnification image data at a second magnification thereby obtaining second magnification image data;
an image output unit that outputs any one of the first magnification image data obtained by the first magnification changing unit, the first magnification image data in the image storage unit, and the second magnification image data obtained by the second magnification changing unit as output image data;
a magnification setting unit that sets a magnification of the output image data that is to be output from the image output unit;
an operation mode setting unit that sets an operation mode from among an image quality priority mode, a productivity priority mode, and a balance priority mode in which image quality and productivity are balanced; and
a magnification distribution controlling unit that controls magnification distribution between the first magnification and the second magnification based on the operation mode set by the operation mode setting unit and the magnification set by the magnification setting unit.

2. The image processing apparatus according to claim 1, wherein the magnification distribution controlling unit controls the magnification distribution between the first magnification and the second magnification to set the first magnification at no magnification and the second magnification at the magnification set by the magnification setting unit when the operation mode set by the operation mode setting unit is the image quality priority mode and the magnification set by the magnification setting unit is other than the first magnification.

3. The image processing apparatus according to claim 1, wherein the magnification distribution controlling unit controls the magnification distribution between the first magnification and the second magnification to set the first magnification at the magnification set by the magnification setting unit and the second magnification at no magnification when the operation mode set by the operation mode setting unit is the productivity priority mode and the magnification setting unit sets a specific magnification.

4. The image processing apparatus according to claim 3, wherein the magnification distribution controlling unit controls the magnification distribution between the first magnification and the second magnification to set the first magnification at no magnification and the second magnification at the magnification set by the magnification setting unit when the operation mode set by the operation mode setting unit is the productivity priority mode for enlarging the image data and the magnification set by the magnification setting unit corresponds to image enlargement.

5. The image processing apparatus according to claim 1, wherein
the magnification distribution controlling unit comprises a static resolution determining unit that determines a static resolution by assigning a predetermined resolution to each of some segmented ranges based on the magnification set by the magnification setting unit, and
the magnification distribution controlling unit controls the magnification distribution between the first magnification and the second magnification such that the image data is stored at the static resolution determined by the static resolution determining unit when the operation mode set by the operation mode setting unit is the balance priority mode.

6. The image processing apparatus according to claim 5, wherein the static resolution determining unit further comprises an adjusting unit that enables ranges to be adjusted and resolutions to be assigned when assigning a resolution to the image data.

7. The image processing apparatus according to claim 5, wherein the magnification distribution controlling unit controls the magnification distribution between the first magnification and the second magnification such that the image data is stored for both main and sub scanning directions at a static resolution determined by the static resolution determining unit and corresponding to a higher output resolution set in either direction, when separate magnifications are to be used for the horizontal and portrait directions of the image data, and when the operation mode set by the operation mode setting unit is the image quality mode and the magnification setting unit sets separate magnifications for the main and sub scanning directions.

8. The image processing apparatus according to claim 1, further comprising a selecting unit with which a user selects an operation mode from among the image quality priority mode, the productivity priority mode, and the balance priority mode, wherein
the operation mode setting unit sets the operation mode selected by the user with the selecting unit.

9. An image processing method comprising:
first processing including processing input image data at a first magnification thereby obtaining first magnification image data and storing the first magnification image data in an image storage unit;
second processing including processing the first magnification image data at a second magnification thereby obtaining second magnification image data;
outputting any one of the first magnification image data obtained at the first processing, the first magnification image data in the image storage unit, and the second magnification image data obtained at the second processing as output image data;
magnification setting including setting a magnification of the output image data that is to be output at the outputting;
mode setting including setting an operation mode from among an image quality priority mode, a productivity priority mode, and a balance priority mode in which image quality and productivity are balanced; and
controlling magnification distribution between the first magnification and the second magnification based on the operation mode set at the mode setting and the magnification set at the magnification setting.

10. The image processing method according to claim 9, wherein the controlling includes controlling the magnification distribution between the first magnification and the second magnification to set the first magnification at no magnification and the second magnification at the magnification set at the magnification setting when the operation mode set at the mode setting is the image quality priority mode and the magnification set at the magnification setting is other than the first magnification.

11. The image processing method according to claim 9, wherein the controlling includes controlling the magnification distribution between the first magnification and the second magnification to set the first magnification at the magnification set at the magnification setting and the second magnification at no magnification when the operation mode set at the mode setting is the productivity priority mode and the magnification set at the magnification setting is a specific magnification.

12. The image processing method according to claim 11, wherein the controlling includes controlling the magnification distribution between the first magnification and the second magnification to set the first magnification at no magnification and the second magnification at the magnification set at the magnification setting when the operation mode set at the mode setting is the productivity priority mode for enlarging the image data and the magnification set at the magnification setting corresponds to image enlargement.

13. The image processing method according to claim 9, wherein
the controlling includes determining a static resolution by assigning a predetermined resolution to each of some segmented ranges based on the magnification set at the magnification setting, and
the controlling includes controlling the magnification distribution between the first magnification and the second magnification such that the image data is stored at the static resolution determined at the determining when the operation mode set at the mode setting is the balance priority mode.

14. The image processing method according to claim 13, wherein the determining includes enabling ranges to be adjusted and resolutions to be assigned when assigning a resolution to the image data.

15. The image processing method according to claim 13, wherein the controlling includes controlling the magnification distribution between the first magnification and the second magnification such that the image data is stored for both main and sub scanning directions at a static resolution determined at the determining and corresponding to a higher output resolution set in either direction, when separate magnifications are to be used for the horizontal and portrait directions of the image data, and when the operation mode set at the mode setting is the image quality mode and separate magnifications are set at the magnification setting for the main and sub scanning directions.

16. The image processing method according to claim 9, further comprising causing a user to select an operation mode from among the image quality priority mode, the productivity priority mode, and the balance priority mode, wherein
the mode setting includes setting the operation mode selected by the user.

17. A computer program product that includes a computer-readable recording medium that contain a computer program which when executed on a computer causes the computer to execute:
first processing including processing input image data at a first magnification thereby obtaining first magnification image data and storing the first magnification image data in an image storage unit;
second processing including processing the first magnification image data at a second magnification thereby obtaining second magnification image data;
outputting any one of the first magnification image data obtained at the first processing, the first magnification image data in the image storage unit, and the second magnification image data obtained at the second processing as output image data;
magnification setting including setting a magnification of the output image data that is to be output at the outputting;
mode setting including setting an operation mode from among an image quality priority mode, a productivity priority mode, and a balance priority mode in which image quality and productivity are balanced; and
controlling magnification distribution between the first magnification and the second magnification based on the operation mode set at the mode setting and the magnification set at the magnification setting.
